(19) United States
(12) Patent Application Publication
(10) Pub. No.: US 2025/0123445 A1
(43) Pub. Date: Apr. 17, 2025

(54) MATCHED FIBER OPTIC CONNECTOR PAIR FORMED USING SEPARATE FIBER BODIES

(71) Applicant: CORNING RESEARCH & DEVELOPMENT CORPORATION, CORNING, NY (US)

(72) Inventors: Timothy Winston Anderson, Newton, NC (US); Lars Martin Otfried Brusberg, Corning, NY (US); Davide Domenico Fortusini, Ithaca, NY (US); Steven Joseph Gregorski, Painted Post, NY (US); Randy LaRue McClure, Corning, NY (US); Peter J. Tuscany, Columbia Crossroads, PA (US); Todd Marshall Wetherill, Painted Post, NY (US); Pierre Beneke, Berlin (DE); Eric James Paulus, Corning, NY (US)

(21) Appl. No.: 18/918,328

(22) Filed: Oct. 17, 2024

Related U.S. Application Data
(60) Provisional application No. 63/544,525, filed on Oct. 17, 2023.

(51) Int. Cl. G02B 6/36; G02B 6/25; G02B 6/38

(52) U.S. Cl. CPC G02B 6/3636; G02B 6/25; G02B 6/3882; G02B 6/3885

(57) ABSTRACT

Matched fiber optic connectors are formed by aligning separate fiber bodies and then cutting optical fibers secured in the separate fiber bodies. The matched pair of fiber optic connectors are capable of supporting high-fiber count connectivity. The process includes placing optical fibers into a first fiber body aligned with a second fiber body with the optical fibers traversing a predetermined gap between the first end face and the second end face of the fiber bodies and securing the optical fibers to the fiber bodies using an adhesive. The optical fibers are cut at the predetermined gap between the aligned end faces of respective fiber bodies, thereby creating a first fiber optic connector having the first ends of the cut optical fibers matched and suitable for optical mating with the second ends of the cut optical fibers in a second fiber optic connector.

### RELATED APPLICATIONS

This application claims the benefit of priority of U.S. Provisional Application Ser. No. 63/544,525 filed on Oct. 17, 2023, the content of which is relied upon and incorporated herein by reference in its entirety.

### FIELD

Matched fiber optic connectors formed using a process of providing separate first and second fiber bodies having optical fibers attached therein and then the cutting the optical fibers between a predetermined gap between the first and second fiber bodies are disclosed. More specifically, the matched fiber optic connectors are formed by adding adhesive into the aligned first and second fiber bodies for securing a plurality of optical fibers across the predetermined gap. Thereafter, the cutting of the optical fibers secured to the separate fiber bodies at the predetermined gap provides a matched pair of fiber optic connectors for dedicated optical mating.

### BACKGROUND

Optical fiber is increasingly being used for a variety of applications, including but not limited to broadband voice, video, and data transmission. As bandwidth demands increase the optical fiber networks for data center applications are becoming larger and denser with the need to organize and optically interconnect larger numbers of optical fibers optically mated with fiber optic connectors. Conventional multi-fiber fiber optic connectors such as MT fiber optic connectors use a ferrule having an individual bore for receiving and precisely locating respective optical fibers at the ferrule end face for optical mating.

In general, high-density fiber optic connectors become much more difficult to manufacture and maintain low optical losses as the number of optical fibers of the connector increases. Conventional multi-fiber optic connectors work well, however; as the number of optical fibers held by the ferrule increases so does the difficulty in making a reliable optical connection. Thus, fiber optic connectors using conventional multi-fiber ferrules for holding individual optical fibers have practical limits for higher fiber-count optical connectors due to optical performance or manufacturing yield-rates that may be challenging to achieve and maintain.

There exists a need for improved designs for high-density fiber optic connectors that ease manufacturing while still providing a quick and easy optical connectivity for optical networks.

### SUMMARY

The disclosure is directed to a matched pair of fiber optic connectors formed by a process comprising the steps of providing a first fiber body comprising at least one first optical fiber slot extending from a first end face along a longitudinal length of the first fiber body and providing a second fiber body comprising at least one second optical fiber slot extending from a second end face along a longitudinal length of the second fiber body. Aligning the first fiber body with the second fiber body so that the first end face of the first fiber body and the second end face of the second fiber body are adjacently disposed with a predetermined gap between the first end face and the second end face. Placing a plurality of optical fibers into the at least one first slot of the first fiber body and the at least one second slot of the second fiber body in a predetermined arrangement, and the plurality of optical fibers traverse the predetermined gap between the first end face and the second end face. Adding an adhesive into the at least one first slot of the first fiber body and the at least one second slot of the second fiber body for securing the plurality of optical fibers to the first fiber body and the second fiber body and cutting the plurality of optical fibers at the predetermined gap between the first end face of the first fiber body and the second end face of the second fiber body, thereby creating a first fiber optic connector comprising the first fiber body comprising first ends of the cut plurality of optical fibers suitable for optical mating with a second fiber optic connector comprising the second fiber body comprising second ends of the cut plurality of optical fibers.

The predetermined gap between the between the first end face and the second end face of the aligned first and second fiber bodies can be selected to be wider than the cutting width of the respective cutting blade kerf as appropriate. Consequently, the process can avoid cutting of the respective fiber bodies securing the optical fibers. The predetermined gap may also be selected so that the cut optical fibers protrude beyond the respective first end face and the second end face after the cutting of the optical fibers. Further, the length of cut optical fibers protruding beyond the respective first end face and the second end face may also be selected to provide a suitable fiber length for removal during a mechanical polishing process for one or more of the respective ends of the cut optical fibers as desired. Consequently, the process for making matched pairs of fiber optic connector is suitable for creating fiber optic connectors having a maximum mating loss of 0.3 dB or less with much larger fiber counts compared with conventional fiber optic connectors.

The matched pair of fiber optic connectors may further include a connector package for optical mating. The connector package may comprise an alignment backbone for supporting the precision alignment of the first and second fiber optic connectors for optical mating. The connector packaging can optionally include other features such as a cover, sealing, one or more end caps, pushes, stops or the like as desired. The connector packaging may also be designed for indoor, outdoor or indoor/outdoor applications as desired such as by environmentally sealed for weatherproofing or the like.

In other embodiments, the process may optionally further include securing alignment features to the respective fiber bodies of the matched pair of fiber optic connectors after the cutting of the aligned optical fibers at the predetermined gap. After cutting of the optical fibers to create the matched pair of fiber optic connectors, then the fiber optic connectors can be precision aligned for securing alignment features.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the concepts and are incorporated into and constitute a part of this specification. The drawings illustrate various embodiments and together with the description serve to explain the principles and operation.

### BRIEF DESCRIPTION OF THE FIGURES

FIG. 1 is a schematic representation of the process for making a matched pair of fiber optic connectors using separate and aligned first and second fiber bodies having respective first and second fiber slots and securing a plurality of optical fibers using an adhesive and then cutting the optical fibers at a predetermined gap between the first and second fiber bodies for the concepts disclosed herein;

FIG. 2 depicts an explanatory alignment fixture providing a datum for precision alignment of reference surfaces on a first design of fiber bodies each fiber body having respective slots aligned with a predetermined gap between first and second end faces of the fiber bodies for securing a plurality of optical fibers to first and second fiber bodies using an adhesive;

FIGS. 3 and 4 respectively are perspective and end face views of a second embodiment of fiber bodies have a cylindrical profile with planar reference surfaces configured as a V-shaped portion for precision alignment for making a matched pair of fiber optic connectors by securing a plurality of optical fibers in respective fiber slots traversing a predetermined gap between aligned first and second end faces and then cutting of the optical fibers at the predetermined gap.

FIGS. 5 and 6 respectively depict another explanatory alignment fixture providing a datum for precision alignment of the reference surfaces on the fiber bodies of FIGS. 3 and 4;

FIG. 7 is a perspective view of an alignment backbone comprising ball mounts for maintaining precision alignment of fiber bodies for optical mating and/or making a matched pair of fiber optic connectors;

FIG. 8 shows a sectional view of the alignment backbone of FIG. 7 showing the ball supports supported in pockets with different elevations within the V-shaped cradle for precision alignment;

FIG. 9 is a perspective view showing the alignment and optical mating of the matched pair of fiber optic connectors after cutting the optical fibers using the alignment backbone of FIGS. 7 and 8;

FIG. 10 shows a perspective view of an explanatory connector package comprising an alignment backbone for precision alignment of the matched pair of fiber optic connectors disclosed by the process herein.

FIG. 11 is an exploded view of the explanatory connector package similar to FIG. 10 using the alignment backbone for optical mating of the matched pair of fiber optic connectors optically mated using the alignment backbone of the connector packaging;

FIG. 12 is a cross-sectional view of the alignment backbone of FIG. 11 showing a V-shaped cradle along with pockets disposed on different elevations of the cradle for receiving the plurality of ball supports that engage the reference support surfaces for maintaining the precision alignment of the matched pair of fiber optic connectors during optical mating.

FIG. 13 is a longitudinal sectional view of the assembled connector package of FIG. 11.

FIG. 14 is another longitudinal sectional view of the assembled connector package of FIG. 11 showing further details of the connector package.

FIGS. 15A and 15B are perspective views of showing first alignment feature concepts that may be used with the matched pair of fiber optic connectors using guide pins and bores for maintaining precision alignment for optical mating of the matched pair.

FIG. 15C is a detailed view showing the alignment feature concepts of FIGS. 15A and 15B using a tapered pin secured to the first fiber body using adhesive and the cooperating tapered bore disposed on the second fiber body for precision alignment of the matched pair of fiber optic connectors.

FIGS. 16A-16F are perspective views showing a second alignment feature concepts that may be used with the matched pair of fiber optic connectors by injecting adhesive into one of the respective fiber bodies of the matched pair of fiber optic connectors;

FIGS. 17A-17F are perspective views showing a third alignment feature concepts that may be used with the matched pair of fiber optic connectors using a sleeve and pin arrangement for precision alignment of the matched pair of fiber optic connectors;

FIG. 18 is a perspective view of showing a matched pair of fiber optic connectors having alignment features that are attached to the first and second fiber bodies prior to cutting the plurality of optical fibers at the predetermined gap formed between the first fiber body and the second fiber body;

FIG. 19 is an exploded perspective view of the matched pair of fiber optic connectors of FIG. 18;

FIGS. 20-23 depict other variations of first and second fiber bodies that may be used with the concepts disclosed herein;

FIGS. 24-26 depict details for attaching the alignment features to the respective first and second fiber bodies of the matched pair of fiber optic connectors prior to cutting the plurality of optical fibers as depicted in FIGS. 18 and 19;

FIGS. 27-30 depict further steps for making the matched pair of fiber optic connectors depicted in FIGS. 18 and 19; and

FIGS. 31 and 32 depict the alignment and optical mating of the matched pair of fiber optic connectors depicted in FIG. 18.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts disclosed herein are directed to a matched pair of fiber optic connectors formed by a process that aligns a first fiber body with a second fiber body and secures a plurality of optical fibers that traverse a predetermined gap between the first fiber body and the second fiber body. The plurality of the optical fibers that traverse the predetermined gap between the first and second fiber bodies may be precisely aligned and secured to the respective fiber bodies using an adhesive. Thereafter, the plurality of optical fibers and/or any adhesive may be cut at the predetermined gap for creating the matched pair comprising a first fiber optic connector and a second fiber optic connector as disclosed herein. Generally speaking, the matched pair of fiber optic connectors can be optically mated and optically unmated when properly aligned as desired. Further, the first and second fiber bodies may optionally further include alignment features added to the respective fiber bodies after the cutting of the plurality of optical fibers if desired.

The concepts disclosed advantageously disclose an improved process for making matched pairs of high-fiber count fiber optic connectors. Since the first and second fiber bodies do not have precision optical fiber bores that receive the mating optical fibers, the number of optical fibers secured to the first and second fiber bodies can be greatly increased in a matched pair of fiber optic connectors as discussed herein. The disclosed process provides fiber optic connectors that advantageously allow fiber optic connectors supporting high-count optical fiber connectors without using conventional ferrules and without having to cut through a body or fiber support carrying the plurality of optical fibers. Conventional multifiber ferrules use precision fiber bores in the ferrule for receiving and aligning respective optical fibers and become increasing more difficult to manufacture as fiber count is increased. The process for making the matched pair of fiber optic connectors is simple and elegant for manufacturing while advantageously being able to handle optical-fiber connector counts not possible with conventional fiber optic connectors.

The matched pair of fiber optic connectors made by the process disclosed advantageously allows a relatively dense array of optical fibers for the mated interconnection between the first and second optical fiber connectors produced while still being suitable for rugged or demanding environments if desired. For instance, the materials for the fiber bodies may be selected from any suitable material such as a polymer, metal, glass, ceramic, glass-ceramic, but other suitable materials are possible according to the concepts disclosed.

Further, the fiber optic connectors made according to the concepts disclose may further include a connection package for optical mating. A connector package may comprise an alignment backbone for supporting the precision alignment of the first and second fiber optic connectors for optical mating.

As optical networks increase densifications and space may be at a premium fiber optic connectors having high-fiber count fiber optic connectors are advantageous, and present concepts disclose robust, high-density fiber optic connectors in a compact form-factor. The concepts disclosed herein are suitable for high-density interconnect applications such as for data-centers, trunk cables and 5G applications and are equally applicable to other optical applications as well including indoor, automotive, industrial, wireless, or other suitable applications.

Additionally, the concepts disclosed may be used with any suitable combination of optical fibers selected from the group of single-mode, multi-mode, multi-core, polarization maintaining or other combinations of suitable optical fibers as desired since the optical connectors are made as a matched pair for providing a dedicated optical mating of the complimentary fiber optic connectors made during manufacturing. Thus, any secured combination of optical fibers (regardless of fiber type, number of cores, etc.) that traverse the aligned predetermined gap before cutting will be suitable for alignment with the dedicated fiber optic connector after cutting the plurality of optical fibers at the predetermined gap between the respective fiber bodies. Various steps, designs, constructions, or features for making a matched pair of fiber optic connectors are disclosed in more detail as discussed herein and may be modified or varied as desired.

The disclosed process for making the matched pair of fiber optic connectors using first and second fiber bodies that are spaced apart sufficiently and avoid the need to cut the end faces of the first and second fiber bodies, thereby making the connector manufacturing process easier and quicker. Along with improving the cleanliness of the cut by not introducing a foreign fiber body material into the optical fiber array during the step of cutting. Any suitable type of cutting process may be used for cutting the plurality of optical fibers once secured by adhesive to the aligned first and second fiber bodies 50, 80. For instance, a predetermined gap may be selected to be wider than the cutting blade or device used. The concepts will be described in more detail herein.

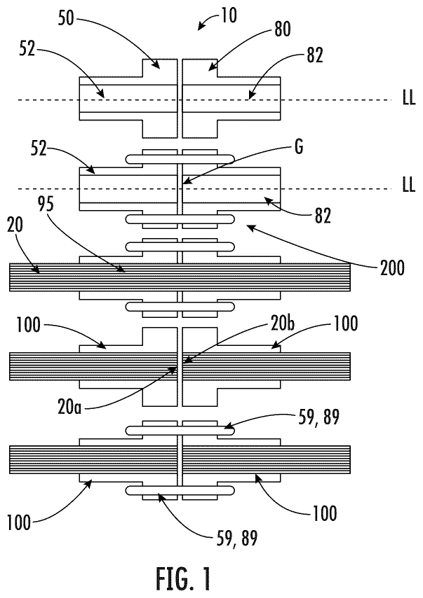

FIG. 1 is a schematic representation of an explanatory process for making a matched pair of fiber optic connectors 100, 100 according to the disclosure. The process comprises providing a first fiber body 50 and a second fiber body 80 that are aligned with a predetermined gap G between the respective first and second end faces 55, 85 (visible in FIG. 4). The alignment of the fiber bodies 50, 80 may be accomplished using an alignment bed or the like as represented by the horizontal lines on opposite sides of the respective fiber slots 52, 82 and represent an alignment fixture. An adhesive 95 may be added for securing a plurality of optical fibers 20 that traverse the predetermined gap G between the first fiber body 50 and second fiber body 80. Then, cutting of the plurality of optical fibers 20 at the predetermined gap G between the first fiber body 50 and the second fiber body 80 creates the matched pair of fiber optic connectors 100, 100 with matched optical fiber ends 20a, 20b as shown. The first and second fiber bodies 50, 80 may have similar, the same, or different shapes, geometry or features as desired and may be aligned using a suitable alignment fixture.

Suitable alignment fixtures may have appropriate support locations for the fiber bodies such as ball supports or the like disposed in an alignment bed 200, alignment backbone 300 or the like for proper alignment. Further, the ball supports that may move or translate for providing a kinematic fixturing, and other fixturing surfaces or features may be used with or without ball supports as desired. For instance, the alignment fixtures or devices may materials that are hardened, lapped or polished for flatness and/or smooth surface finishes. By way of explanation, the ball supports may be precision diameter hardened or polished ball supports if desired. Other variations for the fiber bodies are possible according to the concepts disclosed.

If desired, the process may further include optional alignment features 59, 89 being added to the respective fiber bodies 50, 80 of the matched pair of fiber optic connectors 100, 100 after the cutting of the optical fibers 20.

The process disclosed includes providing the separate first fiber body 50 with at least one first optical fiber slot 52 and the second fiber body 80 with the at least one second optical fiber slot 82 for making the matched pair of fiber optic connectors 100, 100. The respective optical fiber slots 52, 82 extend from respective end faces 55, 85 along longitudinal length LL of the fiber bodies 50, 80. As shown, the longitudinal lengths LL of the first fiber body 50 and second fiber body 80 may aligned so that the opposing end faces 55, 85 are aligned such as being disposed on an alignment fixture such as an alignment bed 200, an alignment backbone 300 or the like with a predetermined gap G. The alignment fixture is represented by the solid lines parallel with the longitudinal length LL illustrated above and below the fiber slots 52, 82 as shown in FIG. 1.

When aligned, one or more first fiber slot(s) 52 extend from a first end face 55 of first fiber body 50 along a longitudinal length LL of the first fiber body 50, and one or more second fiber slot(s) 82 extends from a second end face 85 of the second fiber body 80 along the longitudinal length LL of the second fiber body 80. Once the respective fiber bodies 50, 80 are precision aligned using appropriate reference surfaces 50R, 80R disposed on the respective fiber bodies 50, 80, then the fiber bodies 50, 80 that form the fiber optic connectors with cut optical fibers can be realigned using these reference surfaces 50R, 80R on the respective fiber bodies 50, 80.

Consequently, the alignment of the plurality of optical fibers casily allows high-fiber count matched pair fiber optic connectors. For instance, the concepts disclosed are suitable for thirty-two optical fibers or greater with ease. The optical fibers 20 may be layered into the aligned fiber slots 52, 82 and secured using adhesive 95. Optical fibers 20 may have any suitable construction such as bare optical fibers, coated fibers, ribbons or the like. Processes for preparing the optical fibers 20 for making the matched pair of fiber optic connectors 100 may include the step of mid-span accessing a cable by removing the cable jacket and any strength members or tubes to reach the optical fibers 20. Thereafter, the optical fibers 20 may be stripped of ribbon coating and any optical fiber coating as desired before being placed within the aligned fiber slots 52, 82. By way of example, a 144-fiber count cable having twelve 12-fiber ribbons may have its cable jacket and strength members removed over a suitable mid-span length for accessing the optical fiber ribbons within the fiber optic cable. Then, the ribbon coatings and/or one or more coatings may be removed from of the optical fibers 20 before placement in the aligned fiber slots 52, 82 for making a 144-fiber count matched pair of fiber optic connectors 100, 100 with suitable optical mating performance. Index matching gel may be used for mating the fiber optic connectors 100, 100 for improving optical performance.

By way of explanation, suitable optical performance may have a maximum optical loss of 0.30 dB or lower for the optical mating of the cut ends of the optical fibers 20 in the matched pair of fiber optic connectors 100, 100. Thus, making fiber optic connectors according to the disclosed process allow much higher fiber counts for optical mating compared with conventional fiber optic connectors. Other values for optical mating performance may be possible with the concepts as well for making lower-loss matched pair of fiber optic connectors such as all of the optical fibers 20 of the array having a 0.20 dB or less of optical loss when used with an index-matching gel or other suitable index matching material.

Any suitable optical fiber counts for fiber optic cables are possible for the disclosed concepts such as using 288-fiber, 576-fiber counts, etc. Moreover, the processes could make fiber optic cable assemblies having multiple matched pairs of fiber optic connectors terminated at one or more mid-span access points along the length of the fiber optic cable. Further, the concepts include hybrid connector cable assemblies terminated with conventional connectors on end(s) and matched pair of fiber optic connectors at one or more midspan access locations along the fiber optic cable.

The step of aligning the first fiber body 50 with the second fiber body 80 so the first end face 55 of the first fiber body 50 and the second end face 85 of the second fiber body 80 are adjacently disposed with a predetermined gap G between the first end face 55 and the second end face 85 as schematically depicted. The process for making the matched pair of fiber optic connectors 100, 100 also comprises and placing a plurality of optical fibers 20 that traverse a predetermined gap (G) between first and second fiber bodies 50, 80 on an alignment bed or other suitable alignment fixture. As the plurality of optical fibers are placed for traversing the predetermined gap (G) and an adhesive 95 may be added and cured for securing the plurality of optical fibers 20 to the respective first and second fiber bodies 50, 80. The optical fibers 20 may also be held in tension for maintaining the optical fibers 20 essentially parallel with the axis of the aligned fiber bodies 50, 80 during processing. For instance, a force of about ten Newton or less may be applied to the optical fibers near the distal ends of the fiber bodies 50, 80 during manufacture to aid in maintaining the optical fibers essentially parallel.

For instance, adhesive 95 may be added in layers with the optical fibers 20 as desired. By way of explanation, the respective bottom surface of the fiber slots 52, 82 may have a layer of adhesive 95 applied before the first optical fibers 20 are placed into the respective fiber slots 52, 82 of the first fiber body 50 and the second fiber body 80 in a predetermined arrangement so that the optical fibers 20 traverse the predetermined gap G between the first end face 55 and the second end face 85. Further adhesive 95 and/or optical fibers 20 may be placed into the at least one first optical fiber slot 52 of the first fiber body 50 and the at least one second optical fiber slot 82 of the second fiber body 80.

Moreover, the optical fibers could be single optical fibers, bundles of optical fibers, arrays of optical fibers such as optical ribbons or the like may be placed into the optical fiber slots 52, 82 in a layering process of optical fibers 20 and adhesive 95 or placed as a bulk of optical fibers 20 for creating the optic fiber array that traverses the predetermined gap (G) for mating with the fiber optic connectors 100, 100. After curing of the adhesive 95, the cutting of the plurality of optical fibers 20 at the predetermined gap (G) for making the matched pair of high-density optical fiber connectors 100, 100 is performed. The cutting of the optical fibers 20 at the predetermined gap G between the first and second fiber bodies 50, 80 creates the matched pair of fiber optic connectors 100, 100.

The concepts disclosed herein may use the precision and repeatable alignment using reference surfaces on cooperating first and second fiber bodies along with securing the plurality of the optical fibers with adhesive to traverse the predetermined gap of cooperating matched pair fiber optic connectors when aligned. Cleanliness and reliability of the process may include an optional step where the predetermined gap G is filled for inhibiting leakage of the adhesive 95 from the predetermined gap G. For instance, the use of a gasket or dam between the first and second end faces 55, 85 of the fiber bodies 50, 80 when aligned inhibits adhesive from leaking out from the predetermined gap G between the first and second fiber bodies and may help keep an uniform spacing. For instance, once the fiber bodies are aligned a silicone or other material may be used to fill the predetermined gap for inhibiting leakage of the adhesive 95. Other gaskets or dams can include foam or rubber membrane or the like for inhibiting leakage of adhesive. Thereafter, the plurality of optical fibers may be cut across the predetermined gap (along with removing any gasket or dam or not as desired) for creating the matched pair of fiber optic connectors with the dedicated optical mating.

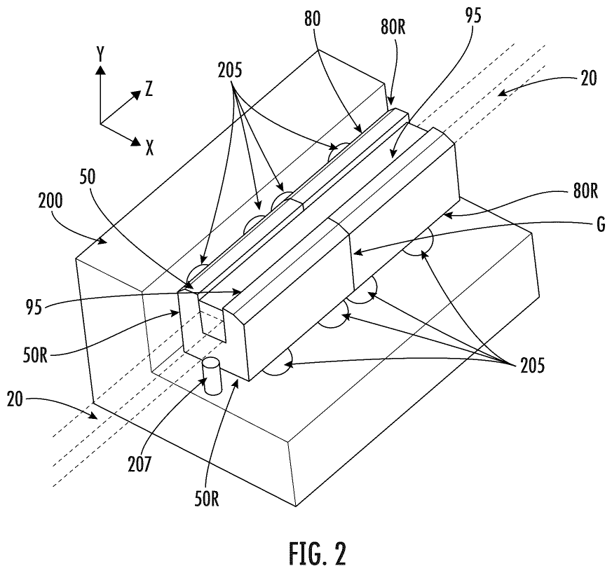

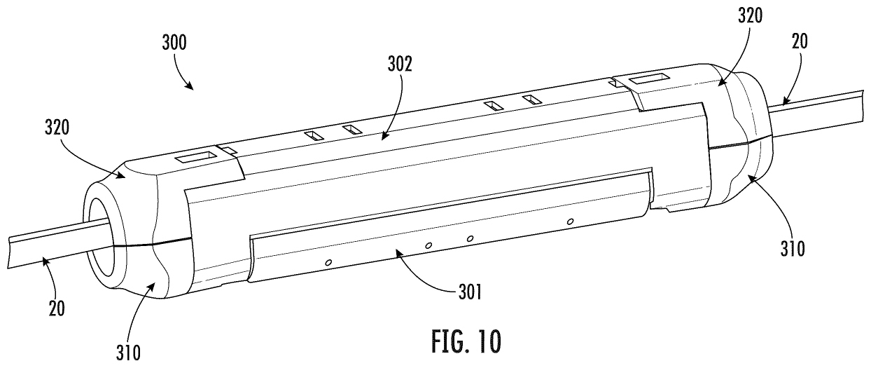

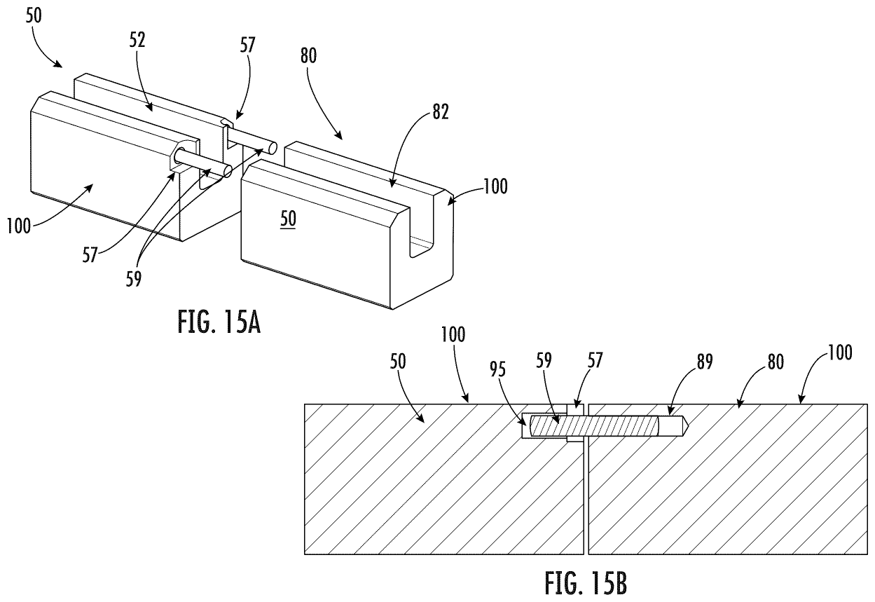

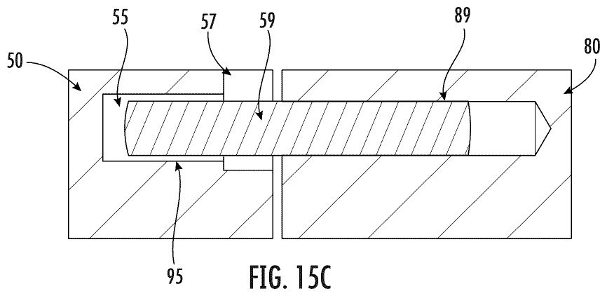

FIGS. 2-9 depict various fiber bodies along with alignment fixtures or alignment beds useful for making the matched pair of fiber optic connectors 100, 100 and FIGS. 10-14 depict explanatory connector packages 300 having an alignment backbone 301 for an outer packaging useful for optical mating of the matched pair of fiber optic connectors 100, 100 if desired. FIGS. 15-17F depict various optional alignment features 59, 89 that may be added to the matched pair of fiber optic connectors 100, 100 after the cutting of the optical fibers 20 for part of a connector package or otherwise providing easy alignment or stability for the matched pair of optical connectors 100, 100 as desired. Although, concepts are described with respect to specific fiber bodies for use with optional connector packages or alignment features the concepts for making the matched pair of fiber optic connectors 100 may be used with any suitable fiber bodies, connector packages, or alignment features, alignment backbones or devices.

FIG. 2 depicts a first explanatory alignment bed 200 useful for providing a datum for precision and repeatable alignment of the fiber bodies 50, 80 using respective reference surfaces 50R, 80R of the first and second fiber bodies 50, 80. The first explanatory fiber bodies shown in FIG. 2 have a rectangular profile with a U-shaped slot in cross-section. The concepts disclosed may be used with any suitable profile for the fiber-bodies along with any suitable profile for the respective slots that secure the optical fibers. Likewise, the fiber bodies 50, 80 may comprise any suitable material for the desired application. For robust applications a rugged and weather resistant material may be desirable such as a stainless steel, glass, ceramic, glass-ceramic, or other suitable material for the application. Other variations of materials are also possible such as highly-filled polymers or other materials having suitable performance for the desired application.

The reference surfaces for the respective fiber bodies are datum surfaces that cooperate with the alignment reference planes of the alignment fixture or device for precision alignment. Specifically, the fiber bodies 50, 80 each comprise two reference surfaces 50R, 80R that cooperate with the two respective alignment reference planes of the alignment bed 200 or other device used. By way of explanation, the reference surfaces 50R, 80R can extend over a portion of the length of the respective bodies 50, 80. The reference surfaces 50R, 80R may be formed as orthogonal surfaces that extend along the length of the respective bodies 50, 80 such as depicted. The reference surfaces 50R, 80R for these fiber bodies 50, 80 are located on adjacent sides that are generally orthogonal.

For instance, the alignment reference planes of the alignment bed 200 or other alignment fixtures may be orthogonal at X-Y alignment planes and cooperate for precision aligning the X-Y axis of fiber bodies 50, 80 using the reference surfaces 50R, 80R for alignment in a repeatable manner along the reference surfaces 50R, 80R disposed on the X-Y axes of the fiber bodies 50, 80. Alignment bed 200 or other alignment fixtures may also comprise an end stop for repeatable position in the Z-direction for precision alignment.

As shown, the bottom sides of the respective fiber bodies 50, 80 are first reference surfaces 50R, 80R for alignment bed 200, and the far sides of the respective fiber bodies 50, 80 are second reference surfaces 50R, 80R for alignment bed 200. For precision alignment, the fiber bodies 50, 80 are tightly pushed to the alignment reference planes of the alignment bed 200 and may be clamped in place for maintaining the alignment position. Alignment bed 200 also includes an end stop 207 configured as a protruding pin located on the bottom reference plane of the alignment bed 200 for maintain a repeatable longitudinal position on the reference planes in the Z-direction.

To aid in precision alignment, the alignment fixtures and devices disclosed may comprise ball supports arranged on one or more alignment planes of the alignment fixture for supporting reference surfaces on the respective fiber bodies. As shown in FIG. 2, alignment bed 200 comprises ball supports 205 arranged on the respective alignment planes, but alignment planes may have other arrangements if desired. Additionally, the ball supports 205 may be arranged in number and location to create a datum for the reference surfaces 50R, 80R of the fiber bodies 50, 80 that is not over-constrained, thereby providing precise and repeatable positioning for alignment bodies 50, 80 for securing the optical fibers 20 to the fiber bodies 50, 80. The precision alignment of the fiber bodies 50, 80 is used when making the matched pair of fiber optic connectors 100, 100 along with optical mating of the fiber optic connectors 100, 100. Specifically, after securing and cutting the optical fibers 20 in precision alignment, thereby forming the matched pair of fiber optic connectors 100, 100 the matched pair of fiber optic connectors 100, 100 may be precision aligned using reference surfaces 50R, 80R in alignment for optical mating of the respective optical fiber ends 20a, 20b.

Once the fiber bodies are properly aligned in the alignment fixture or device such as alignment bed 200 the securing of the optical fibers 20 using adhesive 95 within the respective optical fiber slots 52, 82 is possible. As shown, the plurality of the optical fibers 20 are secured with adhesive 95 and traverse the predetermined gap (G) between the aligned fiber bodies 50, 80 before cutting of the optical fibers 20 for creating the matched pair of fiber optic connectors 100, 100.

FIG. 2 also shows the uncut assembly of optical fibers 20 on the alignment bed 200 after curing of the adhesive 95. The cutting of the plurality of optical fibers 20 may also occur while the assembly is in the alignment fixture or not using any suitable cutting method. The step of cutting the plurality of optical fibers 20 may also include the cutting of adhesive 95 at the predetermined gap (G). The step of cutting the optical fibers 20 may also include cutting of the gasket or dam disposed at the predetermined gap (G). The predetermined gap (G) is selected so the cutting of the optical fibers avoids cutting the end faces 55, 85 of the fiber bodies 50, 80 depending on the type of cutting process used. By way of explanation, a diamond-wire saw having an 80-μm nominal wire diameter may be used for cutting step such as a model 3500P diamond saw available from WELL Diamond Wire Saws SA. The actual kerf produced by the wire saw is slightly larger than the wire diameter such as between 85 to 95 μm. If a polishing process is used an additional 20-40 micrometers of optical fiber material may be lost in the polishing process of the end faces of cut optical fibers 20, and the predetermined gap G and/or temporary gasket of dam may be selected accordingly.

Advantageously, the cut optical fiber ends 20a, 20b protrude beyond the end faces 55, 85 of the fiber bodies 50, 80. By way of example, the optical fiber ends 20a, 20b protrude beyond the end faces 55, 85 by at least 10 microns or more after cutting. One embodiment has the optical fiber ends 20a, 20b protruding beyond the end faces 55, 85 by at least 30 microns or more after cutting. Additionally, the optical fiber ends 20a, 20b may be polished for improved optical mating or performance of the matched pair of fiber optic connectors 100, 100 if desired.

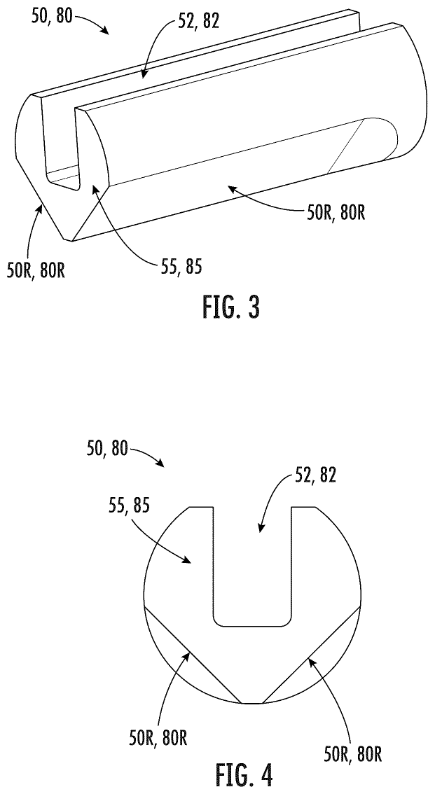

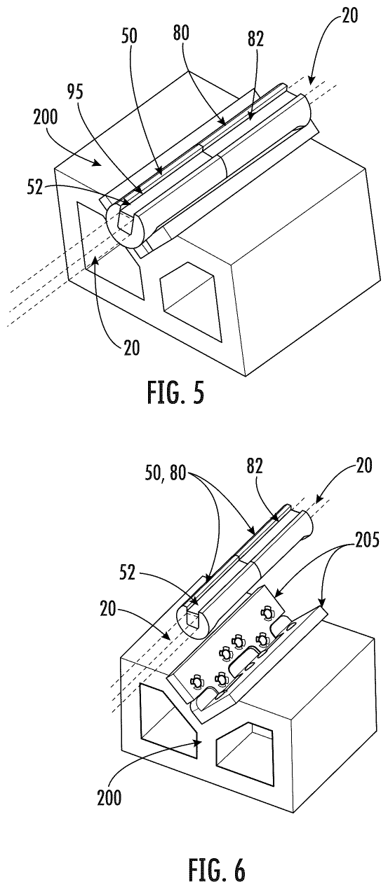

Of course, other shapes are possible for fiber bodies 50, 80 along with related alignment fixtures of devices for the same. By way of explanation, FIGS. 3 and 4 depict a second design for fiber bodies 50, 80 and FIGS. 5-9 depict suitable alignment fixtures or devices for the fiber bodies 50, 80 of FIGS. 3 and 4 for making the matched pair of fiber optic connectors 100, 100. FIGS. 10-14 depict explanatory connector packages 300 useful for optical mating of the matched pair of fiber optic connectors 100, 100, if desired. FIGS. 15-17F depict various optional alignment features 59, 89 that may be added to the matched pair of fiber optic connectors 100, 100 as desired.

Fiber bodies 50, 80 of FIGS. 3 and 4 each comprise a cylindrical body portion with reference surfaces 50R, 80R of the respective first and second fiber bodies 50, 80 comprising a V-shaped portion as depicted. As best shown in FIG. 4, the cylindrical body portion comprises planar surfaces orthogonally arranged as the V-shaped portion below the optical fiber slots 52, 82 as reference surfaces 50R, 80R. These reference surfaces 50R, 80R provide a datum for the respective fiber bodies 50, 80 for precision alignment when making a matched pair of fiber optic connectors 100, 100 along with alignment of the fiber optic connectors 100, 100 for optical mating as disclosed herein.

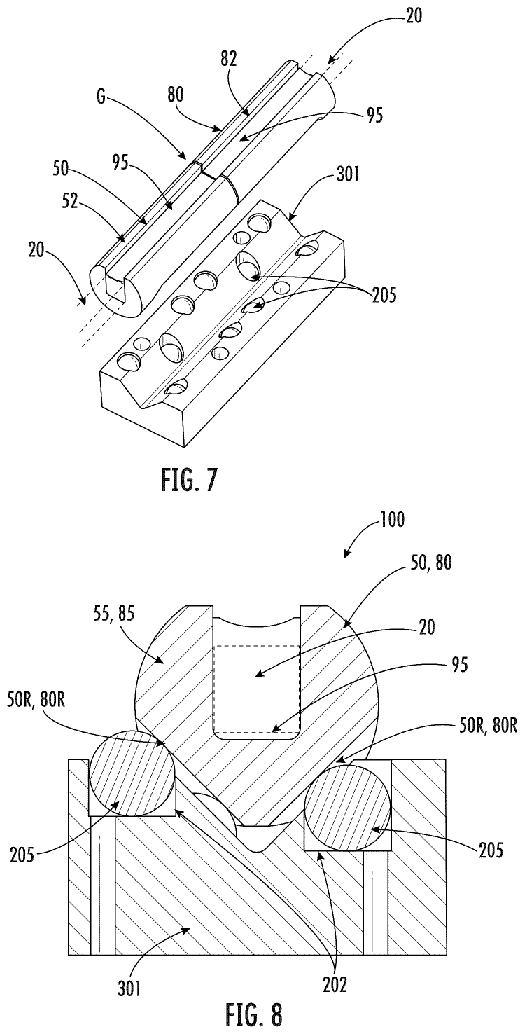

Specifically, the fiber bodies 50, 80 of FIGS. 3 and 4 may be used with alignment fixtures or devices as discussed herein. FIGS. 6 and 7 show an alignment bed 200 for aligning the fiber bodies 50, 80 disclosed herein. This alignment bed 200 comprises a V-shaped body for supporting alignment reference planes for aligning the fiber bodies 50, 80. The alignment bed 200 comprises ball supports 205 arranged on the respective alignment reference planes as shown in FIG. 6, and alignment beds and other alignment reference planes may use other suitable arrangements if desired.

The alignment fixtures and alignment beds allow the steps of aligning the first fiber body 50 with a second fiber body 80 so that the first end face of the first fiber body and the second end face of the second fiber body are adjacently disposed with a predetermined gap G with the first end face and the second end face for securing the optical fibers 20 in the respective optical fiber slots 52, 82. The optical fibers may also be cut at the predetermined gap G while disposed within the alignment fixture or alignment bed if desired, or not. However, the alignment fixtures or alignment beds are intended for repeated use for manufacturing.

The present application also discloses alignment backbones 301 for providing an alignment datum for the matched pair of fiber optic connectors 100, 100. The alignment backbones 301 are useful as part of a connector package that allows optical mating for the matched pair of fiber optic connectors 100, 100. Generally speaking, the alignment backbones 301 disclosed herein are compact and provide a structure for maintaining the matched pair of fiber optic connectors 100, 100 in an aligned and mated state. Further, the alignment backbone 301 may be used as part of connector packages that may provide environmental protection for the mated matched pair of fiber optic connectors 100, 100.

FIGS. 7-9 show views of a precision alignment backbone 301 for aligning first and second fiber bodies 50, 80 shown in FIGS. 3 and 4. Alignment backbone 301 is useful for use during manufacturing and being a portion of a connector package 300 if desired. Alignment backbone 301 allows securing a plurality of optical fibers 20 in respective optical fiber slots 52, 82 traversing a predetermined gap (G) between respective first and second end faces 55, 85 before cutting of the optical fibers 20, which may occur in the alignment backbone 20. Alignment backbone 301 uses ball supports 205 for cooperating with reference surfaces 50R, 80R of the first and second fiber bodies 50, 80 as shown. The ball supports 205 are arranged on the V-shaped cradle of the alignment backbone 301 and disposed within respective pockets 202 of the alignment backbone 301 as depicted. FIG. 8 shows a sectional view showing the elevation of the ball supports 205 within the V-shaped cradle of the alignment backbone 301. As depicted, ball supports 205 are disposed in a respective pocket 202 of the alignment backbone 301. The pocket 205 and ball supports are arranged along the alignment backbone 301 so the datum provided by the reference alignment planes of the alignment backbone 301 is not over-constrained.

As depicted, the pockets 205 may be disposed at different elevations along the length of the alignment backbone 301. FIG. 8 shows a sectional view of the ball supports 205 for engaging the reference surfaces 50R, 80R of the first and second fiber bodies 50, 80. As shown, the ball support 205 on the left-side of FIG. 8 has a different elevation for supporting the respective reference surfaces 50R, 80R than the elevation of the ball support 205 on the right-side of FIG. 8. Using two different elevations for the balls support allows the creation of a stable and precise alignment fixture. For instance, three of the supports of the alignment fixture may have a triangular or tripod pattern for stability on the first alignment datum and the second alignment datum uses two supports for creating a stable alignment fixture, thereby providing a suitable alignment datums for precision alignment of fiber bodies in the alignment fixture or device. Other arrangements for alignment fixtures or devices are possible as well.

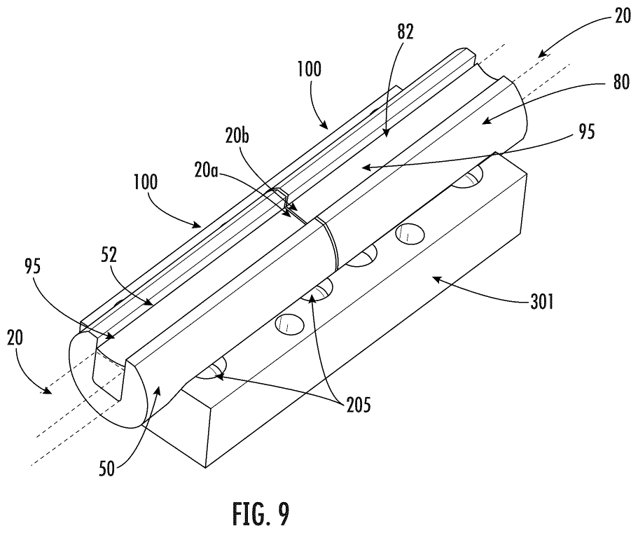

FIG. 9 shows the alignment backbone 301 of FIGS. 7 and 8 used for aligning and supporting the optical mating of the matched pair of fiber optic connectors after the optical fibers have been cut. Alignment backbone 301 may form a portion of a connector package for supporting the optical mating of the matched pair of fiber optic connectors 100, 100 if desired. The connector package using alignment backbone 301 may be as simple as using adhesive or potting for securing the optical mating of the matched pair of fiber optic connectors 100, 100 to the alignment backbone 301.

In other variations, alignment backbones 301 may be configured for cooperating with other components for forming connector packages 300 such as depicted in FIGS. 10-14. FIG. 10 shows a perspective view of an assembled explanatory connector packaging 300 comprising an alignment backbone 301 for precision alignment of the matched pair of fiber optic connectors 100, 100 that are disposed within the connector package 300 and optically mated.

The connector packaging 300 may optionally further include a cover 302 that engages with the alignment backbone 301. By way of example, cover 302 may be fitted to the shape of the alignment backbone 301 and have cooperating mechanical structure for retention. As an example, the cover 302 may align and attach to the alignment backbone 301 in any suitable manner such as a snap-fit, fasteners, slide or flex of the cover 302 for engagement. Other covers 302 for connector packages may be attached with fasteners and optionally include a gasket or seal between the alignment backbone 301 and cover 302 if desired.

Alignment backbone 301 may have any suitable structure for precision alignment of the matched pair of fiber optic connectors 100, 100. Alignment structures disclosed herein may or may not use the support balls for precision alignment as desired or not. Further, the alignment backbone 301 can be modified for other applications as desired.

Connector package 300 may have any suitable configuration or components for optical mating of the matched pair of fiber optic connectors 100, 100. Connector package 300 may have other optional components as well. By way of explanation, connector package 300 may optionally have one or more end caps for protecting the optical fiber 20 entrance into the connector packaging 300. As depicted, the connector package 300 may optionally comprise a lower end caps 310 and an upper end cap 320 as shown. The lower end cap 310 and upper end cap 320 can cooperate with cover 302 or alignment backbone 301 for assembly. The end caps may also be used to inhibit sharp bending of the optical fibers 20. A heat shrink could also be used over the connector package 300 if desired.

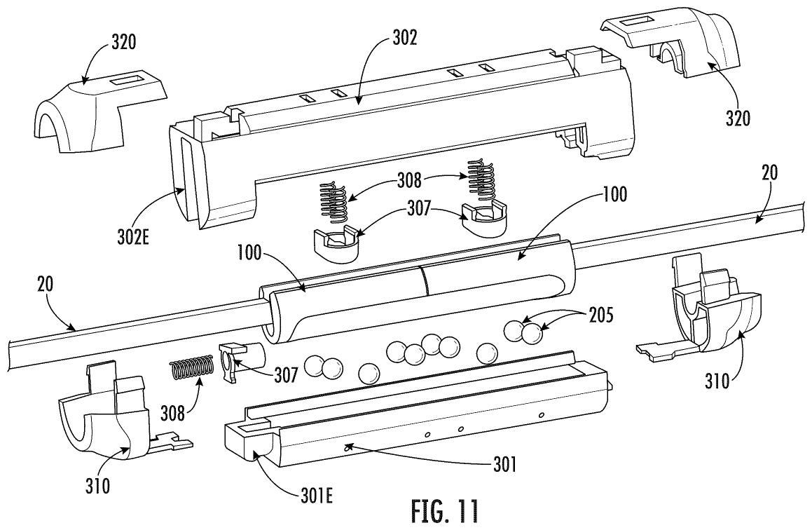

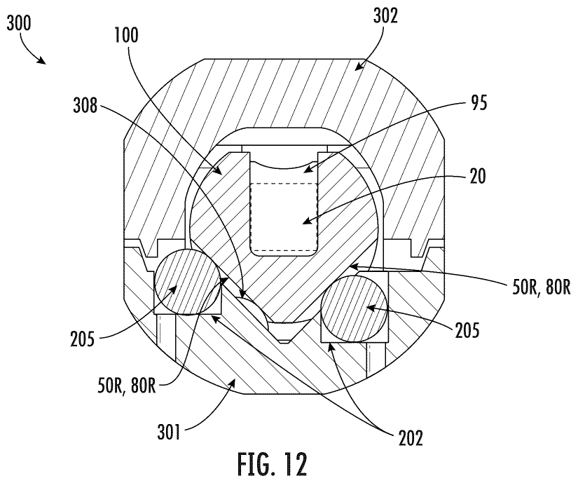

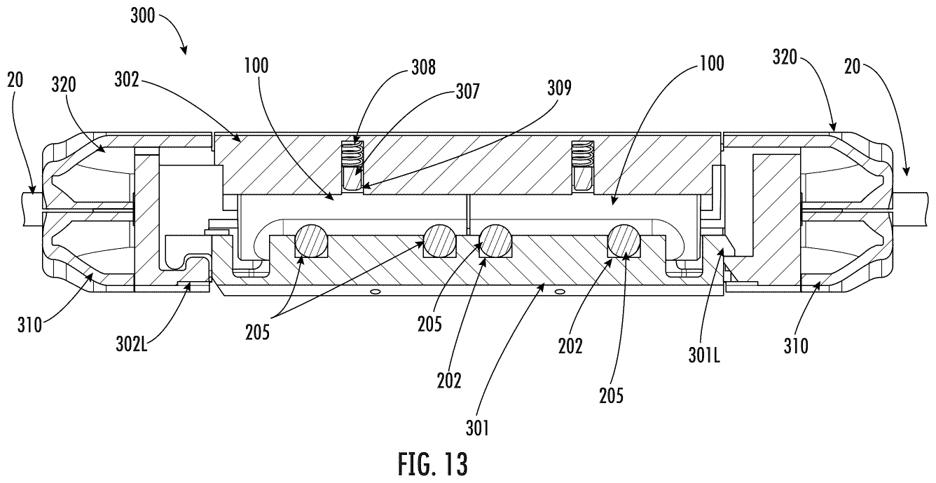

FIG. 11 is an exploded view of the connector package 300 similar to FIG. 10 having alignment backbone 301. As shown, alignment backbone 301 has a plurality of ball supports 205 for supporting the reference surfaces 50R, 80R and providing precision alignment during optical mating of the matched pair of fiber optic connectors 100, 100 as discussed herein and shown in FIGS. 12 and 13. As shown, connector package 300 may have other optional components as well.

The connector package 300 may also comprise one or more pushes 307 for biasing the fiber optic connectors 100, 100 to the alignment backbone 301 within the connector package 300. The optional pushes 307 for providing forces to register the respective fiber optic connectors 100, 100 of the matched pair to the alignment datum of the connector package 300 such as the ball supports 205 or the like. Push 307 may also be associated with a spring 308 for biasing a respective fiber optic connector 100 toward the alignment backbone 301 using the fiber optic push 307 when assembled.

Components of the connector package may be assembled together and cooperate. By way of explanation, FIG. 13 depicts cover 302 may comprise at least one passageway 309 for receiving a respective push 307. Pushes 307 may also include one or more latch arms to allow a snap-fit attachment to the cover for retaining the spring 308 and making assembly easier. Pushes 307 may be biased toward the alignment datum using a resilient member 308 for applying a force to the respective push 307 while maintaining the push 307 attached to the cover 302. More specifically, the resilient member 308 is disposed between the push 307 and a portion of the connector package 200 such as the cover 302. The push 307 and any associated resilient member 308 may be fitted into a suitable sized passageway 309 or cooperate with the cover 302 or end caps.

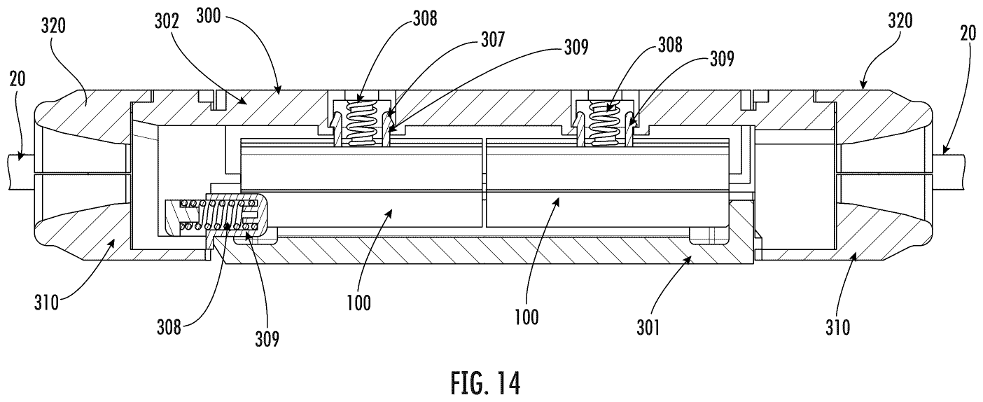

As shown, connector package 300 may comprise three pushes 307. The first two pushes 307 are configured to each engage a respective fiber optic connector 100 by pushing the respective fiber optic connector 100 downward toward the alignment backbone 301. The third push 307 is configured to engage one fiber optic connector 100 and push the matched optical fiber ends 20a, 20b together as shown. Push 307 may take many use constructions or configurations as desired or not be used at all. FIG. 14 is a sectional view of the assembled connector package 300 of FIG. 11 showing details of the alignment backbone 301 fitting to cover 302 along with details of the endcaps 310, 320. Connector package 300 provides precision alignment for optical mating of the matched pair of fiber optic connectors 100, 100.

Cover 302 may also comprise interlocking features that cooperate with the alignment backbone 301 or the end caps. Portions of the cover 302 may also support other structure of the connector package.

Any of the connector packages 300 disclosed herein may optionally be weatherproof by appropriately sealing seams using any suitable means such as gaskets, O-rings, adhesive, sealant, welding, overmolding or the like. To this end, connector package 300 may comprise a sealing element disposed between the alignment backbone 301 and the cover 302 if desired. If the matched pair of fiber optic connectors are not intended for outdoor applications or demanding applications, then the weatherproofing may not be required.

To make identification of the matched pair of fiber optic connectors 100, 100, a marking indicia may be used such as QR codes, bar codes, text or color-coding of the for respective fiber optic connectors 100 the optical fiber 20 or cable (e.g., an orange or green polymer heat shrink) or the like.

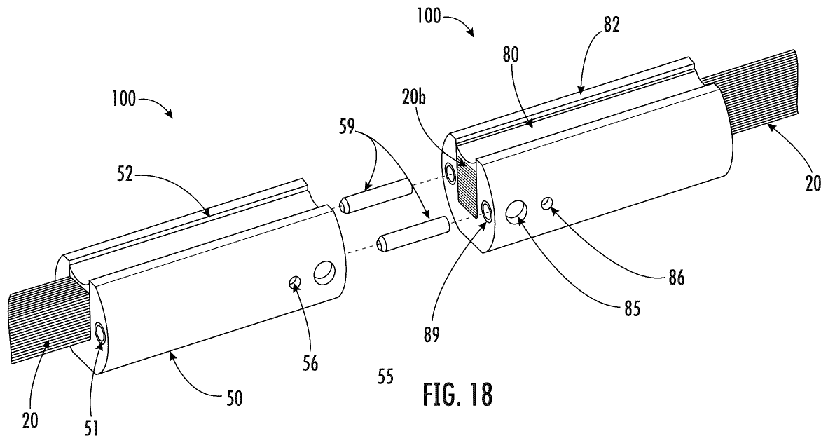

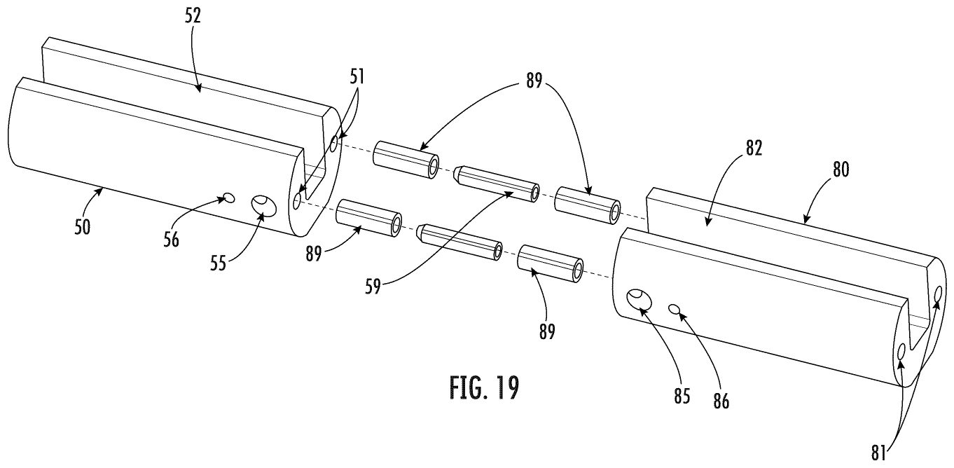

The matched pair of fiber optic connectors 100, 100 may be optionally used with additional features on the respective fiber bodies 50, 80. For instance, the matched pair of fiber optic connectors 100, 100 may include their own optional alignment features added after cutting of the optical fibers 20 such as disclosed in FIGS. 15A-17F with or without the connector package 300 as desired. In other embodiments, the matched pair of fiber optic connectors 100, 100 may include their own optional alignment features that are added before the cutting of the optical fibers 20 such as disclosed in FIGS. 18 and 19. Likewise, the embodiments of FIGS. 18 and 19 may be used with or without the connector package 300 as desired.

FIGS. 15A-17F show variations of the matched pair of fiber optic connectors 100, 100 where the alignment features are added after cutting optical fibers 20. The cut optical fibers 20 secured to the fiber bodies 50, 80 are not shown in FIGS. 15A-17F for the sake of simplicity and highlighting the disclosed alignment features that may be used. Any additional alignment features are added while the matched pair of fiber optic connectors 100, 100 are realigned after cutting the optical fibers 20. Typical alignment features for the matched pair of fiber optic connectors 100, 100 may comprise structure for a male connector and a female connector.

Although, male connectors and female connectors comprising the matched pair of fiber optic connectors are shown FIGS. 15A-17F both connectors of the matched pair of fiber optic connectors will be referenced as “100” in the drawings. Ideally, the matched pair of fiber optic connectors 100, 100 are re-aligned on the same alignment fixture used for making the matched pair of fiber optic connectors when adding the alignment features. Using the same alignment fixture used for making the matched pair for the attachment of alignment features is helpful for maintaining registration of the respective cut optical fiber ends 20a, 20b of the matched pair of fiber optic connectors 100, 100 while securing the optical alignment features.

Generally speaking, the matched pair of fiber optic connectors respectively comprise a first alignment feature 59 disposed or secured on the first fiber body 50 and a second alignment feature 89 disposed or secured on the second fiber body 80. The first alignment feature(s) 59 cooperates with the second alignment feature(s) 89 for aligning the matched pair of fiber optic connectors 100, 100 as shown. For instance, the first fiber body may have alignment pins that cooperate with one or more bores on the second fiber body for receiving the alignment pins for alignment during optical mating.

Illustratively, FIGS. 15A and 15B are perspective views of a first embodiment of alignment features that may be used with the first and second fiber bodies 50, 80 of the matched pair of fiber optic connectors 100, 100. These alignment features 59 are configured as pins and respective bores for precision alignment of the first and second fiber bodies 50, 80. As shown, the alignment features 59 are two pins are disposed on opposite sides of the optical fiber slot 52 of the first fiber body 50 for the first connector 100. The second connector 100 has respective bores 89 formed in the second fiber body 80 that cooperate with alignment features 59 for maintaining the precision alignment.

The required geometry for the respective first and second fiber bodies 50, 80 to accommodate the male and female alignment features requires differing structure for the that is preferably formed in the first and second fiber bodies 50, 80 before aligning and securing the optical fibers 20. However, the attachment for one or more of the alignment features 59, 89 occurs after the cutting of the optical fibers 20 and the realignment of the matched pair of fiber optic connectors 100, 100. By way of explanation, attachment of the one or more alignment features may used any suitable method such as adhesives, press-fit, welding or the like as desired

FIG. 15C is a detailed view of alignment features 59, 89 of first and second fiber bodies 50, 80 for the matched pair of fiber optic connectors 100, 100. The first alignment features 59 are configured as tapered pins secured to the first fiber body 50 using an adhesive 95 or other suitable method of attachment depending on the materials used. The tapered pins cooperate with respective tapered bores 89 disposed on the second fiber body 80. As depicted, an oversized hole (55) is formed in fiber body 50 and the tapered pins fits tight to the tapered bore of the second fiber body 80 during alignment of the first and second fiber bodies 50, 80. Consequently, when the pins are secured with adhesive 95 in the first fiber body the tapered pins are held in an aligned condition using the second fiber body 80. Once the adhesive or other material reaches appropriate strength, then the matched pair of fiber optic connectors 100, 100 may be unmated and the pins will be secured to the first body 50 for use as desired. Fiber body 50 may also include a notch 57 for allowing an excess adhesive 95 to escape and not reach the front end of the fiber body 50. The notch 57 may also provide access for other methods for securing the first attachment feature 59 to fiber body 50 as desired.

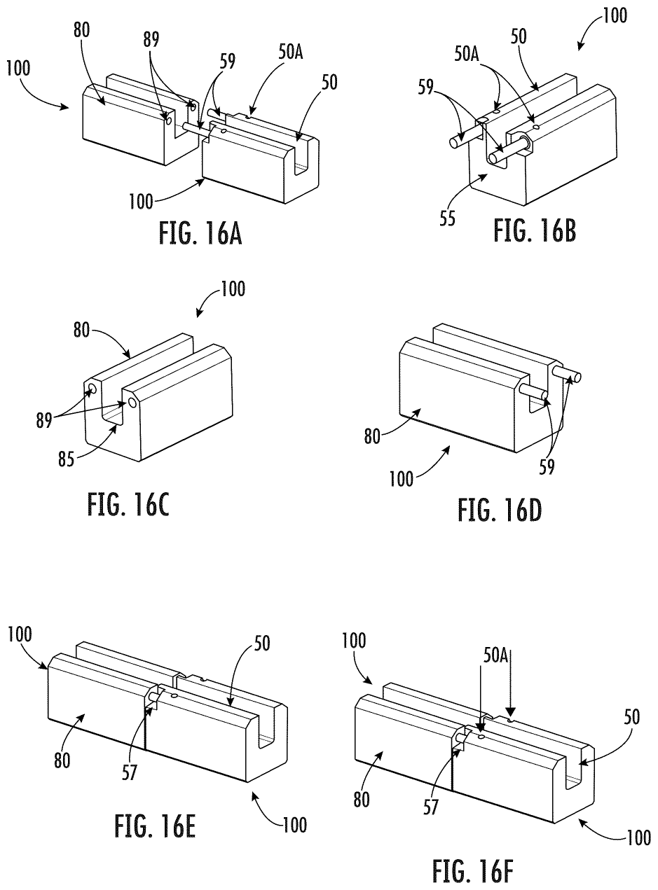

FIGS. 16A-16F are perspective views showing another embodiment of alignment features 59, 89 for the first and second fiber bodies 50, 80 for maintaining precision alignment of the fiber ends 20a, 20b of the optical fibers 20 for optical mating of the matched pair of fiber optic connectors 100, 100. This process for FIGS. 16A-16F is similar to the process for FIGS. 15A-15C using pins in the first fiber body 50 and respective bores in the second fiber body 80 that receive the pins. In this embodiment, the pins need not be tapered, but may have a uniform diameter along its length. The first fiber body 50 also has injection apertures 50A disposed on the top of the fiber body 50 that align with the bores of the fiber body 50 that receive the ends of the alignment features 59 (e.g., the pins). The injection apertures 50A allow easy application of the adhesive 95 into the fiber body 50 while using gravity for aiding the wicking of the adhesive about the alignment feature being secured.

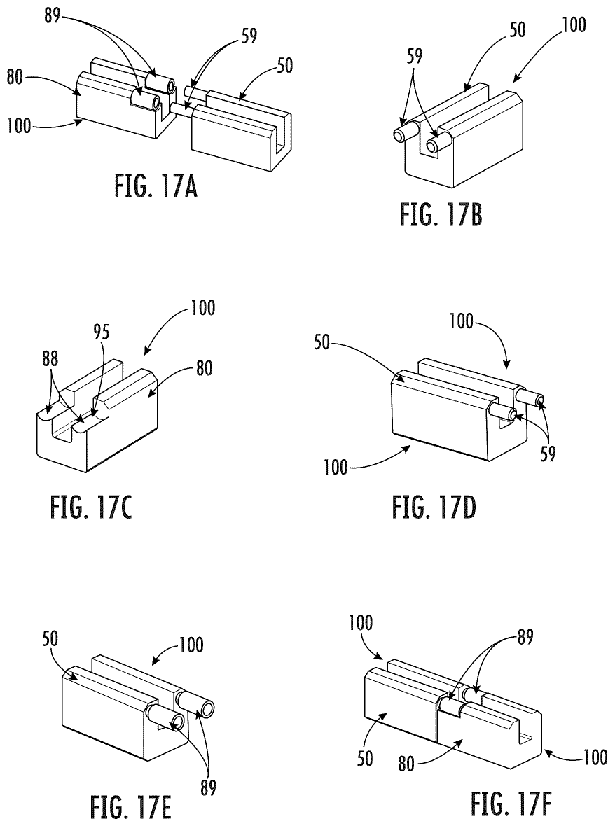

FIGS. 17A-17F are perspective views showing yet another embodiment for alignment features 59, 89 of the first and second fiber bodies 50, 80 for maintaining precision alignment fiber ends 20a, 20b of the optical fibers 20 for optical mating of the matched pair of fiber optic connectors 100, 100. As shown, the first alignment features 59 are configured as alignment pins disposed on the first fiber body 50. If desired, the pins maybe tapered on the side being secured to the first fiber body 50 and disposed within a tapered bore of the first fiber body 50 or not. The pins may be press-fit into bores on the first body 50 and then used as the reference datum for locating the second alignment features on the second fiber body 80. Other configurations or methods for securing the pins are possible.

The first alignment features 59 are configured to cooperate with second alignment features 89 disposed on the second fiber body 80. For instance, the second alignment features 89 on the second fiber body 80 may be secured by adhesive, welding, or the like depending on the materials used. In this version, the second alignment features 89 are configured as sleeves configured for cooperating with the respective pins that are aligned and secured to the first fiber body 80. As shown in FIG. 17D, the sleeves are disposed on the pins secured to the first fiber body 50 as part of the process of the aligning the structure. As shown best in FIG. 17E, the second fiber body 80 comprises one or more saddles 88 shaped for securing the second alignment features 89 thereto. For instance, when being precision aligned the second alignment features (i.e., sleeves) may be disposed on the pins of the first fiber body 50 then the second alignment features of the second fiber body 80 may be secured using any suitable method such as adhesive, welding, etc. as desired and suitable for the materials selected. Then the matched pair of fiber optic connectors 100, 100 may unmated and the sleeves will be secured to the first body 80 and ready for use as desired

FIGS. 18 and 19 show variations of the matched pair of fiber optic connectors 100, 100 where first alignment features 59 are configured for use with second alignment features 89. In this embodiment, the second alignment features 89 are added to the first and second fiber bodies 50, 80 before the cutting optical fibers 20. The fiber bodies 50, 80 and the methods for making the same shown in FIGS. 18-32 are similar to the other fiber bodies depicted herein, but the second alignment features 89 may be attached to the first and second fiber bodies 50, 80 before cutting the optical fibers 20 at the predetermined gap (G). Optical fibers 20 attached and secured to the first and second fiber bodies 50, 80 may be handled in a similar manner as discussed herein as desired. After cutting the optical fibers 20, the first and second fiber bodies may be aligned and mated using first alignment features 59 as depicted in FIG. 18. The embodiments of FIGS. 18-32 may be used with or without the connector package 300 as desired.

The differences of FIGS. 18-32 are described herein and other similar features for will not be discussed for the sake of brevity. FIG. 18 is a perspective view of showing a matched pair of fiber optic connectors 100, 100 having second alignment features 89 that are attached to the first and second fiber bodies 50, 80 prior to cutting the plurality of optical fibers 20 at the predetermined gap (G) formed between the first fiber body 50 and the second fiber body 80. FIG. 19 is an exploded perspective view of the matched pair of fiber optic connectors 100, 100 of FIG. 18.

As best shown in FIG. 19, the second alignment features 89 are configured as sleeves configured for cooperating with the respective fiber alignment features 59. The first fiber body 50 comprises one or more apertures 51 disposed on opposite sides of the optical fiber slot 52. Likewise, the second fiber body 80 comprises one or more apertures 81 disposed on opposite sides of the optical fiber slot 82. The respective bores 51, 81 are sized for receiving the second alignment features 89 in the respective first and second fiber bodies 50, 80. The second alignment features 89 may be attached to the first and second fiber bodies 50 and 80 in any suitable manner such as by using an adhesive or the like. The first alignment features 59 are configured as pins that are sized for being received in the second alignment features 89 (e.g., sleeves) attached to the respective first and second fiber bodies 50, 80. The sleeves are configured for receiving the first alignment features 59 that are configured as pins for aligning first fiber body 50 and second fiber body 80 for mating.

These first and second alignment features 59, 89 may be used for aligning the respective fiber bodies 50, 80 for the placing of optical fibers 20 into the respective slots 52, 82 and then adding adhesive for into the slots 52, 82 for securing the optical fibers. The first and second alignment features 59, 89 may be formed from any suitable material such as a steel or ceramic, but other materials are possible as well. Likewise, the first and second alignment features 59, 89 may have any suitable size such as 1.25 millimeter pins with suitably sized sleeves for receiving the pins. The first alignment features 59 may be solid pins, roll pins or the like as desired.

As discussed herein, the first and second fiber bodies 50, 80 are set with a predetermined gap (G) between the first and second end faces. Thereafter, the first alignment features 59 may be removed from the assembly prior to cutting the optical fibers 20 that are attached to the respective fiber bodies 50, 80. As depicted, the bores 51, 81 may extend the entire length of the fiber bodies, thereby allowing the first alignment feature to be pushed out of the fiber bodies before cutting of the optical fibers 20 begins. Consequently, the optical fibers 20 are cut at the predetermined gap (G) between the fiber bodies 50, 80 without cutting the other structure of the device (e.g., fiber bodies or the first attachment features). The cut optical fibers 20 may be polished or otherwise finished as discussed herein.

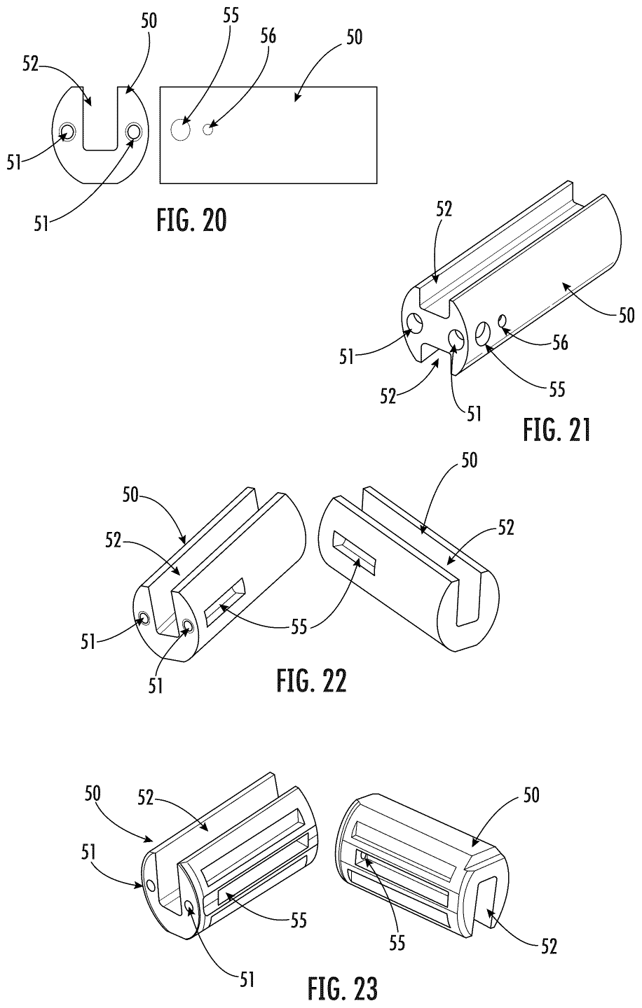

The concepts disclosed herein may be used with any suitable fiber bodies 50, 80 as desired. FIGS. 20-23 depict other variations of first and second fiber bodies 50, 80 that may be used with the concepts disclosed. As shown, the fiber bodies may have any suitable size and shape such as round with one or more flat sides such as shown in FIG. 20. Likewise, the fiber bodies 50, 80 may have any suitable diameter such as 10 millimeters for making a compact connector package, but other sizes are possible as well. FIG. 21 shows another profile for fiber bodies configured as a H-shaped body, thereby providing a first slot and a second slot for receiving a first plurality of optical fibers 20 and a second plurality of optical fibers 20. Other variations of fiber bodies are also possible that aid in manufacturing of the matched pair connectors. For instance, FIGS. 22 and 23 depict fiber bodies 50, 80 having one or more openings 55 configured as side slots, thereby allowing the first alignment sleeves 59 to be removed from the fiber bodies without having to push the same over the entire length of the fiber body before allowing removal when needed. Side slots may also help with the assembly and securing of the second alignment features 89 to the respective fiber bodies.

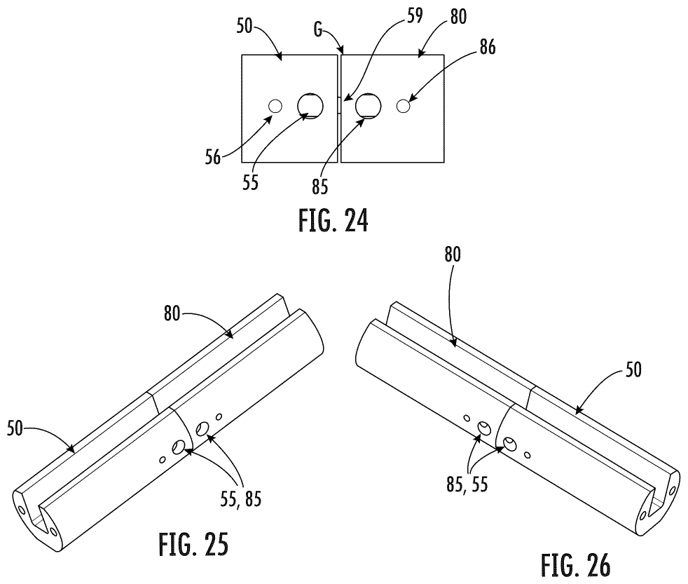

FIGS. 24-26 depict details for attaching the second alignment features 89 to the fiber bodies 50, 80 of FIGS. 18 and 19. Similar concepts may be used with other fiber bodies as desired. FIG. 24 shows a close-up detail of the second alignment features 89 attached to the respective first and second fiber bodies 50, 80 and the fiber bodies aligned using first alignment feature 59 with a predetermined gap (G). By way of explanation, the respective fiber bodies 50, 80 of FIGS. 18-32 may comprise one or more openings 55, 56 that are in communication with the respective bores 51, 81. When installed, the second alignment features 89 are flush or recessed from the respective end faces of the fiber bodies 50, 80. The respective openings 55 may be used for inserting adhesive into the respective bores 51, 81 and providing suitable window for metering and viewing the bonding of the sleeves. Openings 56 may be provided to act as a fixture stop or the like for insertion of the sleeves into the respective fiber bodies to the desired depth. FIGS. 25 and 26 show the fiber bodies 50, 80 from each longitudinal side after being aligned and ready to receive optical fibers 20 in the respective slots 52, 82.

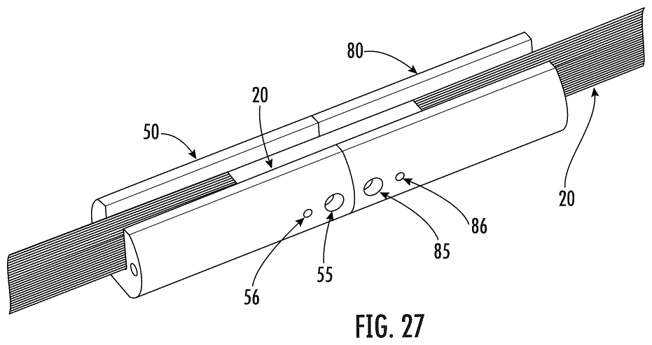

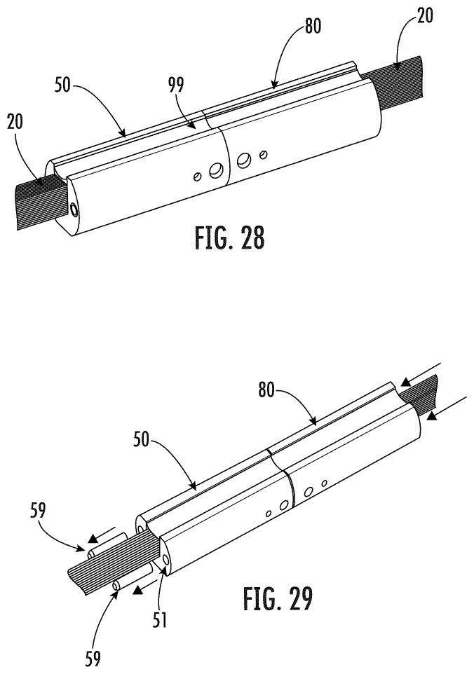

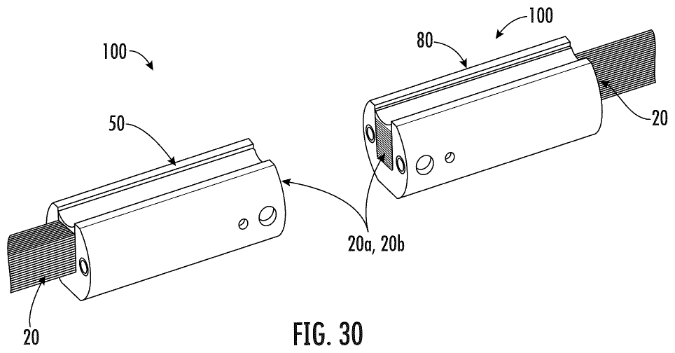

FIGS. 27-30 depict further steps for making the matched pair of fiber optic connectors 100, 100 of FIGS. 18 and 19. As shown in FIG. 27, fiber bodies 50, 80 are aligned using the first and second alignment features 59, 89 with the predetermined gap (G) between the respective end faces. Next, the optical fibers may be stripped of ribbon coatings and aligned across the respective slots 52, 82 and secured using adhesive such as discussed herein. FIG. 28 shows the optical fibers 20 being further potted with adhesive or epoxy for protecting the same. FIG. 29 depicts the first alignment features 59 being pushed out of the second alignment features 89 and fiber bodies 50, 80 as represented by the arrows so that the optical fibers 20 may be cut at the predetermined gap (G) without cutting the first alignment features 59. Once the first alignment features 59 are removed and the optical fibers 20 are cut, then the fiber bodies 50, 80 of the matched pair of connectors 100, 100 may be separated as shown in FIG. 30.

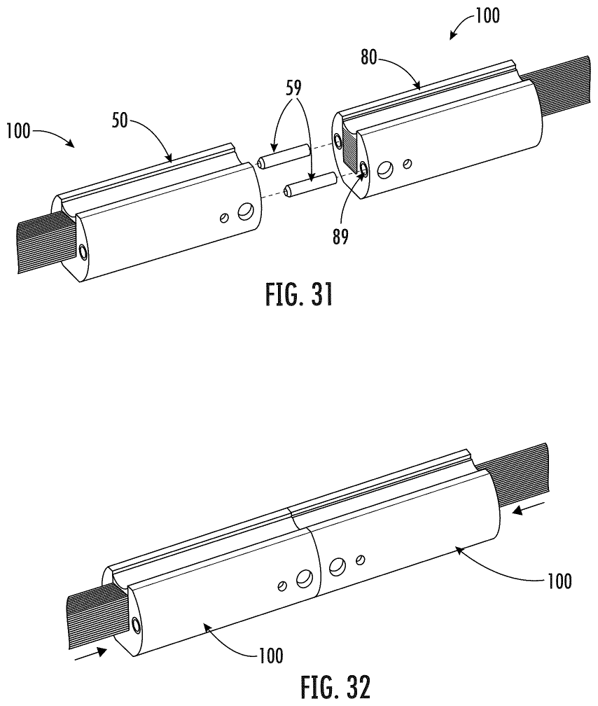

FIG. 31 depict the alignment of the matched pair of fiber optic connectors 100, 100 using first alignment features 59 for optical mating. FIG. 32 shows the matched pair of fiber optic connectors 100, 100 aligned and optically mated using first alignment features 59 and second alignments features on fiber bodies 50, 80.

Still other variations of the matched pair of fiber optic connectors 100, 100 are possible. For instance, the second alignment features 89 could be attached to the respective fiber bodies 50, 80 in other locations if desired. For instance, the fiber bodies could comprise a U-shaped with the second alignment features attached within a portion of the respective fiber slots 52, 82 of the fiber bodies 50, 80 such as in opposing corners of the fiber slots 52, 82. More specifically, these fiber bodies 50, 80 could be formed from any suitable materials such as metal, polymers, glass, ceramics or the like and have the second alignment features 89 configured as sleeves attached to the respective fiber bodies within the respective fiber slots 52, 82 while the first alignment features 59 are configured as pins that are received within the sleeves when mated such as depicted in FIGS. 18 and 19. Other variations for the matched pair of fiber optic connectors using the disclosed concepts are possible as well.

Although the disclosure has been illustrated and described herein with reference to explanatory embodiments and specific examples thereof, it will be readily apparent to those of ordinary skill in the art that other embodiments and examples can perform similar functions and/or achieve like results. For instance, the fiber bodies could be used that comprise a plurality of fiber slots in each respective fiber body for aligning and securing separate groups of optical fibers across a predetermined gap between the respective slots of the fiber bodies before cutting the separate groups of optical fibers in the respective aligned slots as disclosed herein. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A matched pair of fiber optic connectors formed by a process comprising the steps of:
providing a first fiber body comprising at least one first optical fiber slot extending from a first end face along a first longitudinal length of the first fiber body;
providing a second fiber body comprising at least one second optical fiber slot extending from a second end face along a second longitudinal length of the second fiber body;
aligning the first fiber body with the second fiber body so that the first end face of the first fiber body and the second end face of the second fiber body are adjacently disposed with a predetermined gap between the first end face and the second end face;
placing a plurality of optical fibers into the at least one first slot of the first fiber body and the at least one second slot of the second fiber body in a predetermined arrangement, and the plurality of the optical fibers traverse the predetermined gap between the first end face and the second end face;
adding an adhesive into the at least one first slot of the first fiber body and the at least one second slot of the second fiber body for securing the plurality of optical fibers to the first fiber body and the second fiber body; and
cutting the plurality of optical fibers at the predetermined gap between the first end face of the first fiber body and the second end face of the second fiber body, thereby creating a first fiber optic connector comprising the first fiber body and first ends of the cut plurality of optical fibers, wherein the cutting step also creates a second fiber optic connector comprising the second fiber body and second ends of the cut plurality of optical fibers.

2. The matched pair of fiber optic connectors of claim 1, wherein the first ends of the cut plurality of optical fibers protrude beyond the first end face of the first fiber body, and the second ends of the cut plurality of optical fibers protrude beyond the second end face of the second fiber body.

3. The matched pair of fiber optic connectors of claim 1, wherein the first fiber body comprises a first alignment feature, and the second fiber body comprises a second alignment feature, and the first alignment feature is configured to cooperate with the second alignment feature during mating of the first fiber body with the second fiber body.

4. The matched pair of fiber optic connectors of claim 3, wherein the first alignment feature comprises one or more bores and the second alignment feature comprises one or more pins that are configured to cooperate with the one or more bores.

5. The matched pair of fiber optic connectors of claim 4, wherein the one or more bores comprise a tapered bore and the one or more pins comprise a tapered pin.

6. The matched pair of fiber optic connectors of claim 3, wherein the first alignment feature comprises one or more sleeves and the second alignment feature comprises one or more pins that are configured to cooperate with the one or more sleeves.

7. The matched pair of fiber optic connectors of claim 1, wherein the predetermined gap is 2 millimeters or less.

8. The matched pair of fiber optic connectors of claim 1, wherein the first ends of the cut plurality of optical fibers of the first fiber optic connector protrude beyond the first end face of the first fiber body after mechanical polishing of the first ends of the cut plurality of optical fibers.

9. The matched pair of fiber optic connectors of claim 1, wherein the first fiber body comprises a metal, a highly-filled polymer, glass, ceramic, or a glass-ceramic.

10. The matched pair of fiber optic connectors of claim 1, wherein the cutting of the plurality of optical fibers also comprises cutting the adhesive.

11. The matched pair of fiber optic connectors of claim 1, wherein the matched pair of fiber optic connectors is formed by the process further comprising the step of polishing the first ends of the cut plurality of optical fibers disposed in the first fiber body or polishing the second ends of the cut plurality of optical fibers disposed in the second fiber body.

12. The matched pair of fiber optic connectors of claim 1, wherein the plurality of optical fibers comprise single-mode optical fibers.

13. The matched pair of fiber optic connectors of claim 1, wherein the plurality of optical fibers are selected from one or more of the group of single-mode optical fibers, multi-mode optical fibers, multi-core optical fibers, or polarization maintaining fibers.

14. The matched pair of fiber optic connectors of claim 1, wherein the plurality of optical fibers comprise thirty-two optical fibers or greater.

15. The matched pair of fiber optic connectors of claim 1, wherein the predetermined gap includes a gasket or dam for inhibiting adhesive from leaking out from the predetermined gap between the first fiber body and the second fiber body.

16. The matched pair of fiber optic connectors of claim 1, wherein the matched pair of fiber optic connectors is formed by the process further comprising aligning the first fiber body and the second fiber body in an alignment fixture after cutting the plurality of optical fibers for attaching a first alignment feature to the first fiber body and attaching a second alignment feature to the second fiber body.

17. The matched pair of fiber optic connectors of claim 1, further comprising a connector package comprising an alignment backbone and a cover.

18. A matched pair of fiber optic connectors formed by a process comprising the steps of:
providing a first fiber body comprising at least one first optical fiber slot extending from a first end face along a first longitudinal length of the first fiber body, and a first alignment feature;
providing a second fiber body comprising at least one second optical fiber slot extending from a second end face along a second longitudinal length of the second fiber body, and a second alignment feature, wherein the first alignment feature is configured to cooperate with the second alignment feature during mating;
aligning the first fiber body with the second fiber body so that the first end face of the first fiber body and the second end face of the second fiber body are adjacently disposed with a predetermined gap between the first end face and the second end face;
placing a plurality of optical fibers into the at least one first slot of the first fiber body and the at least one second slot of the second fiber body in a predetermined arrangement, and the plurality of the optical fibers traverse the predetermined gap between the first end face and the second end face;
adding an adhesive into the at least one first slot of the first fiber body and the at least one second slot of the second fiber body for securing the plurality of optical fibers to the first fiber body and the second fiber body; and
cutting the plurality of optical fibers at the predetermined gap between the first end face of the first fiber body and the second end face of the second fiber body, thereby creating a first fiber optic connector comprising the first fiber body and first ends of the cut plurality of optical fibers, wherein the cutting step also creates a second fiber optic connector comprising the second fiber body and second ends of the cut plurality of optical fibers.

19. The matched pair of fiber optic connectors of claim 18, wherein the first ends of the cut plurality of optical fibers protrude beyond the first end face of the first fiber body, and the second ends of the cut plurality of optical fibers protrude beyond the second end face of the second fiber body.

20. The matched pair of fiber optic connectors of claim 18, wherein the first alignment feature comprises one or more bores and the second alignment feature comprises one or more pins that are configured to cooperate with the one or more bores.

21. The matched pair of fiber optic connectors of claim 20, wherein the one or more bores comprise a tapered bore and the one or more pins comprise a tapered pin.

22. The matched pair of fiber optic connectors of claim 20, wherein the first alignment feature comprises one or more sleeves and the second alignment feature comprises one or more pins that are configured to cooperate with the one or more sleeves.

23. The matched pair of fiber optic connectors of claim 18, wherein the predetermined gap is 2 millimeters or less.

24. The matched pair of fiber optic connectors of claim 18, wherein the first ends of the cut plurality of optical fibers of the first fiber optic connector protrude beyond the first end face of the first fiber body.

25. The matched pair of fiber optic connectors of claim 18, wherein the first fiber body comprises a metal, a highly-filled polymer, glass, ceramic or a glass-ceramic.

26. The matched pair of fiber optic connectors of claim 18, wherein the cutting of the plurality of optical fibers also comprises cutting the adhesive.

27. The matched pair of fiber optic connectors of claim 18, wherein the matched pair of fiber optic connectors is formed by the process further comprising the step of polishing the first ends of the cut plurality of optical fibers disposed in the first fiber body or polishing the second ends of the cut plurality of optical fibers disposed in the second fiber body.

28. The matched pair of fiber optic connectors of claim 18, wherein the plurality of optical fibers comprise single-mode optical fibers.

29. The matched pair of fiber optic connectors of claim 18, wherein the plurality of optical fibers are selected from one or more of the group of single-mode optical fibers, multi-mode optical fibers, multi-core optical fibers, or polarization maintaining fibers.

30. The matched pair of fiber optic connectors of claim 18, wherein the plurality of optical fibers comprise thirty-two optical fibers or greater.

31. The matched pair of fiber optic connectors of claim 18, wherein the predetermined gap includes a gasket or dam for inhibiting adhesive from leaking out from the predetermined gap between the first fiber body and the second fiber body.

32. The matched pair of fiber optic connectors of claim 18, wherein the matched pair of fiber optic connectors is formed by the process further comprising aligning the first fiber body and the second fiber body in an alignment fixture after cutting the plurality of optical fibers for attaching a first alignment feature to the first fiber body, and attaching a second alignment feature to the second fiber body.

33. The matched pair of fiber optic connectors of claim 18, further comprising a connector package comprising an alignment backbone and a cover.

34. A matched pair of fiber optic connectors formed by a process comprising the steps of:
providing a first fiber body comprising at least one first optical fiber slot extending from a first end face along a first longitudinal length of the first fiber body;
providing a second fiber body comprising at least one second optical fiber slot extending from a second end face along a second longitudinal length of the second fiber body;
aligning the first fiber body with the second fiber body so that the first end face of the first fiber body and the second end face of the second fiber body are adjacently disposed with a predetermined gap between the first end face and the second end face;
placing a plurality of optical fibers into the at least one first slot of the first fiber body and the at least one second slot of the second fiber body in a predetermined arrangement, and the plurality of the optical fibers traverse the predetermined gap between the first end face and the second end face;
adding an adhesive into the at least one first slot of the first fiber body and the at least one second slot of the second fiber body for securing the plurality of optical fibers to the first fiber body and the second fiber body;
cutting the plurality of optical fibers at the predetermined gap between the first end face of the first fiber body and the second end face of the second fiber body, thereby creating a first fiber optic connector comprising the first fiber body and first ends of the cut plurality of optical fibers, wherein the cutting step also creates a second fiber optic connector comprising the second fiber body and second ends of the cut plurality of optical fibers; and
optical mating the first fiber body to the second fiber body and attaching a connector packaging about the mated first fiber body and the second fiber body.

35. The matched pair of fiber optic connectors of claim 34, wherein the first ends of the cut plurality of optical fibers protrude beyond the first end face of the first fiber body, and the second ends of the cut plurality of optical fibers protrude beyond the second end face of the second fiber body.

36. The matched pair of fiber optic connectors of claim 34, wherein the first fiber body comprises a first alignment feature, and the second fiber body comprises a second alignment feature, and the first alignment feature is configured to cooperate with the second alignment feature during mating of the first fiber body with the second fiber body.

37. The matched pair of fiber optic connectors of claim 36, wherein the first alignment feature comprises one or more bores and the second alignment feature comprises one or more pins that are configured to cooperate with the one or more bores.

38. The matched pair of fiber optic connectors of claim 37, wherein the one or more bores comprise a tapered bore and the one or more pins comprise a tapered pin.

39. The matched pair of fiber optic connectors of claim 37, wherein the first alignment feature comprises one or more sleeves and the second alignment feature comprises one or more pins that are configured to cooperate with the one or more sleeves.

40. The matched pair of fiber optic connectors of claim 34, wherein the predetermined gap is 2 millimeters or less.

41. The matched pair of fiber optic connectors of claim 34, wherein the first ends of the cut plurality of optical fibers of the first fiber optic connector protrude beyond the first end face of the first fiber body.

42. The matched pair of fiber optic connectors of claim 34, wherein the first fiber body comprises a metal, a highly-filled polymer, glass, ceramic or a glass-ceramic.

43. The matched pair of fiber optic connectors of claim 34, wherein the cutting of the plurality of optical fibers also comprises cutting the adhesive.

44. The matched pair of fiber optic connectors of claim 34, wherein the matched pair of fiber optic connectors is formed by the process further comprising the step of polishing the first ends of the cut plurality of optical fibers disposed in the first fiber body and/or polishing the second ends of the cut plurality of optical fibers disposed in the second fiber body.

45. The matched pair of fiber optic connectors of claim 34, wherein the plurality of optical fibers comprise single-mode optical fibers.

46. The matched pair of fiber optic connectors of claim 34, wherein the plurality of optical fibers are selected from one or more of the group of single-mode optical fibers, multi-mode optical fibers, multi-core optical fibers, or polarization maintaining fibers.

47. The matched pair of fiber optic connectors of claim 34, wherein the plurality of optical fibers comprise thirty-two optical fibers or greater.

48. The matched pair of fiber optic connectors of claim 34, wherein the predetermined gap includes a gasket or dam for inhibiting adhesive from leaking out from the predetermined gap between the first fiber body and the second fiber body.

49. The matched pair of fiber optic connectors of claim 34, wherein the matched pair of fiber optic connectors is formed by the process further comprising aligning the first fiber body and the second fiber body in an alignment fixture after cutting the plurality of optical fibers for attaching a first alignment feature to the first fiber body and attaching a second alignment feature to the second fiber body.

50. The matched pair of fiber optic connectors of claim 34, the connector package comprising an alignment backbone and a cover.

51. The matched pair of fiber optic connectors of claim 50, the alignment backbone further comprising ball supports.

52. The matched pair of fiber optic connectors of claim 50, wherein the step of cutting avoids cutting both the first end face of the first fiber body and the second end face of the second fiber body.

53. A method for making a matched pair of fiber optic connectors comprising the steps of:
providing a first fiber body comprising at least one first optical fiber slot extending from a first end face along a first longitudinal length of the first fiber body;
providing a second fiber body comprising at least one second optical fiber slot extending from a second end face along a second longitudinal length of the second fiber body;
aligning the first fiber body with the second fiber body so that the first end face of the first fiber body and the second end face of the second fiber body are adjacently disposed with a predetermined gap between the first end face and the second end face;
placing a plurality of optical fibers into the at least one first slot of the first fiber body and the at least one second slot of the second fiber body in a predetermined arrangement, and the plurality of the optical fibers traverse the predetermined gap between the first end face and the second end face;
adding an adhesive into the at least one first slot of the first fiber body and the at least one second slot of the second fiber body for securing the plurality of optical fibers to the first fiber body and the second fiber body; and
cutting the plurality of optical fibers at the predetermined gap between the first end face of the first fiber body and the second end face of the second fiber body, thereby creating a first fiber optic connector comprising the first fiber body and first ends of the cut plurality of optical fibers, wherein the cutting step also creates a second fiber optic connector comprising the second fiber body and second ends of the cut plurality of optical fibers.

54. The method of claim 53, wherein the cutting allows the first ends of the cut plurality of optical fibers protrude beyond the first end face of the first fiber body, and the second ends of the cut plurality of optical fibers protrude beyond the second end face of the second fiber body.

55. The method of claim 53, wherein the first fiber body comprises a first alignment feature, and the second fiber body comprises a second alignment feature, and the first alignment feature is configured to cooperate with the second alignment feature during mating of the first fiber body with the second fiber body.

56. The method of claim 55, wherein the first alignment feature comprises one or more bores and the second alignment feature comprises one or more pins that are configured to cooperate with the one or more bores.

57. The method of any one of claim 53, wherein the plurality of optical fibers comprise single-mode optical fibers.

58. The method of claim 53, wherein the plurality of optical fibers are selected from one or more of the group of single-mode optical fibers, multi-mode optical fibers, multi-core optical fibers, or polarization maintaining fibers.

59. The method of claim 53, wherein the plurality of optical fibers comprise thirty-two optical fibers or greater.

60. The method of claim 53, wherein the predetermined gap includes a gasket or dam for inhibiting adhesive from leaking out from the predetermined gap between the first fiber body and the second fiber body.

61. The method of claim 53, further comprising aligning the first fiber body and the second fiber body in an alignment fixture after cutting the plurality of optical fibers for attaching a first alignment feature to the first fiber body.

62. The method of claim 53, further comprising a connector package comprising an alignment backbone and a cover.
